(19) United States
(12) Patent Application Publication
(10) Pub. No.: US 2004/0108938 A1
(43) Pub. Date: Jun. 10, 2004

(54) Portable electronic locking system and method

(76) Inventor: David A. Entrekin, Omaha, NE (US)

Correspondence Address: CHRISTIE, PARKER & HALE, LLP, P.O. BOX 7068, PASADENA, CA, 91109-7068, US

(21) Appl. No.: 10/315,601

(22) Filed: Dec. 10, 2002

(51) Int. Cl. G05B 19/00

(52) U.S. Cl. 340/5.73

(57) ABSTRACT

An electronic locking system and method for controlling the locking and unlocking of a container or trailer. An electronic lock includes a locking mechanism, and lockable member, an electronic user interface and a memory. The lock components can be included within a housing or distributed throughout the container or trailer. Lock data, such as a unique seal number, is loaded from a source computer to a lock memory. When the container reaches its intended destination, a user inputs a data via a user interface, such as a keypad. If the lock data and the user data match or satisfy other criteria, then the electronic lock can be released, thereby permitting the seal to be broken and access to the container. The lock data can also be based location data such as global positioning system (GPS) data. Timestamp and customer identification data can be loaded to the electronic lock and source computer. A wireless link can be used to transmit data and to monitor the current location of the container in real-time through a GPS system.

### FIELD OF THE INVENTION

This invention relates to a system and method for electronically sealing or locking containers and, in particular, to a system and method for electronically sealing or locking shipping containers for transporting or storing perishable goods, food items, chemicals and other environment or contamination sensitive products.

### DESCRIPTION OF RELATED ART

Perishable goods, such as foodstuffs, food items, syrups and oils are commonly shipped or stored in sealed containers or tanks. The containers are typically sealed at the source or point of shipment until they arrive at their destination where they are unloaded, processed or stored. Similarly, other goods, such as chemicals and other environmentally sensitive substances or materials can also be sealed in secure containers. Such materials are sealed because they can be sensitive to contaminants or changes in air pressure, temperature, or other environmental conditions. Thus, if someone tampers with the container and the seal is broken, the entire shipment of product stored in the container can be contaminated, resulting in potentially significant product and monetary losses.

To ensure that goods are not contaminated, spoiled or destroyed, the container is typically sealed. The seal is typically assigned a number and can be secured with a lock. As a result, the container seal number can be identified or compared to determine whether the seal for a particular shipment was broken, to prevent inadvertent seal breaches, and to determine whether the shipment may be contaminated.

More specifically, when a container leaves a source or shipper, it is typically sealed and the seal is assigned a label or identification number. When the container reaches a customer or destination, the customer compares the seal number he or she was provided to the container seal number. If the seal numbers match, then the customer can assume that the container is still loaded with the product and has not been opened or breached. Thus, the product should not be contaminated, and the customer can break the seal and proceed with unloading the product. Thereafter, the trailer can be loaded with an additional product or cleaned or sterilized to transport the same or different product. Subsequent loads can also be sealed, and the seal can be assigned an identification number.

However, if the seal numbers do not match, then a number of problems may exist. First, different seal numbers can indicate an intermediate seal breach on the container being re-sealed and assigned a different seal number. Thus, the goods can be contaminated without the fault of either the shipper or customer. Second, mismatching seal numbers can indicate that the incorrect product was shipped. Third, mismatching seal numbers can also indicate that the trailer did not reach its intended destination.

Verifying seal identifiers can also be time consuming and cause delays. Delays can detain unloading of the product and stall the delivery truck, thereby delaying the next shipment and reducing efficiency and profitability. A missing seal number can also indicate an intermediate seal breach that can cause the product to be contaminated. In these cases, the shipper and customer may dispute which party is responsible for the costs of the goods, shipping and any consequential losses.

Other known systems use a lock, such as a padlock, to provide security against intentional and inadvertent seal breaches. When a lock is used, the shipper typically places the lock on the container to secure the seal before the product is shipped. While the padlock may reduce seal breaches during transport or storage of the container, the end customer requires the key or combination to open the lock at the destination to unload the product. These known systems, however, have a number of shortcomings.

First, seals that are locked with a padlock or other locking mechanism can still be susceptible to breaches. This is particularly problematic when the container is not monitored, e.g., in transit or in storage. These situations provide vandals with increasing opportunities to break lock, causing the seal to be broken, thereby contaminating the product. Second, if a lock is used, the shipper and customer typically must coordinate with each other such that the customer has the key and/or combination. Such coordination efforts are inconvenient and limit the use of the trailer since the shipper may use the trailer for multiple customers. Thus, other customers may or may not have the key or combination all of the time. Third, some customers may have the key or combination for locks for shipments of a competitor. Changing the key or combination does not solve this problem since the coordination of the changes among customers becomes even more complicated. Fourth, systems using a padlock still typically use seal numbers which involve the same seal number tracking and confirmation problems previously described.

There exists, therefore, a need for a portable electronic locking system and method that provides an integrated and efficient system to track and confirm the location and status of a shipping container or trailer and prevent intentional and inadvertent seal breaches and to prevent contamination of materials or products. An improved system and method would enhance shipping coordination and management for both single and multiple destination loads, reduce contamination of products, and assist with meeting health codes, standards and regulations.

### SUMMARY OF THE INVENTION

The present invention provides an improved locking system and method that uses an electronic lock and electronic confirmation network.

According to one aspect of the present invention, an electronic lock or seal lock includes a housing, locking mechanism, and lockable member that can release and receive part of a container. The lock also includes a user interface, such as a keypad or Liquid Crystal Display (LCD), and a memory. The lock components can be included in the housing. Alternatively, one or more lock components can be integrated into a wall or surface of a trailer or container instead of being housed or integrated into the lock housing. Lock data, such as a unique seal or identification number, is stored in the memory when the container is filled and sealed. When the container reaches its intended destination, a customer inputs data or a code via the user interface within the lock housing. If the lock data and the user data match or satisfy other criteria, then the electronic lock can be released, thereby breaking the seal and permitting access to the product stored in the container.

Also in accordance with the invention, the lock data can be location data, such as global positioning system (GPS) data. When GPS data is used, the lock data can represent GPS coordinates of the destination or location where the lock can be released and the seal can be broken. The input data can be the current location of the container and can be loaded manually or downloaded from a GPS system. If the current location and the destination location or lock data match or satisfy other criteria, then the lock is released to open the container at the proper location.

In further accordance with the invention, the electronic lock can be used as part of a system that includes a source computer and a communications device or port such as a modem or wireless network. The source computer can load the lock data to the lock memory through the port. In addition, data can be sent back to the source computer to be verified. Further, when the lock is released to break the seal, a timestamp representing when the lock was released and an identifier of the customer that released the lock or broke the container seal can be stored to the memory of the electronic lock and uploaded to the source computer.

Another aspect of the present invention relates to a method of electronically controlling the locking and unlocking of a container with an electronic lock. Lock data is downloaded into a memory of the electronic lock. Input data is received through a user interface such as a keypad or LCD. The lock data and input data are compared, and a determination is made whether the lock can be released based on whether the input data and lock data match or satisfy other criteria.

### BRIEF DESCRIPTION OF THE DRAWINGS

FIG. 1 generally illustrates an electronic lock securing a latch of a container;

FIG. 2 is a block diagram of electronic lock components including a keypad user interface, an encoder and a memory;

FIG. 3 is a general system diagram illustrating a source computer having a seal program for managing the locking and releasing of an electronic lock through a communications network;

FIG. 4 is a system diagram illustrating communications between a source computer and an electronic lock;

FIG. 5 is a further alternative system diagram illustrating communications between a source computer and an electronic lock;

FIG. 6 is a further alternative system diagram illustrating wireless communications between a source computer and an electronic lock;

FIGS. 7A-D illustrate different lock configurations including lock components in a housing and components distributed in one or more surfaces or walls of a trailer or using original trailer or container components;

FIG. 8 is a flow diagram illustrating steps to determine whether to release or maintain a container lock based on information communicated over the communications system;

FIG. 9 is a flow diagram illustrating steps to determine whether to release or maintain a container lock that is part of a second shipment based on information communicated over the communications system; and

FIG. 10 is a flow diagram illustrating steps to determine whether to release or maintain a container lock based on location data.

### DETAILED DESCRIPTION OF THE PREFERRED EMBODIMENT

In the following description, reference is made to the accompanying drawings which form a part hereof, and which shows by way of illustration specific embodiments by which the invention may be practiced. It is to be understood that other embodiments may be utilized, as structural changes may be made without departing from the scope of the present invention. First, the components of an electronic lock are described. Then, a communications system including the electronic lock is described. Finally a method for electronically locking containers is described.

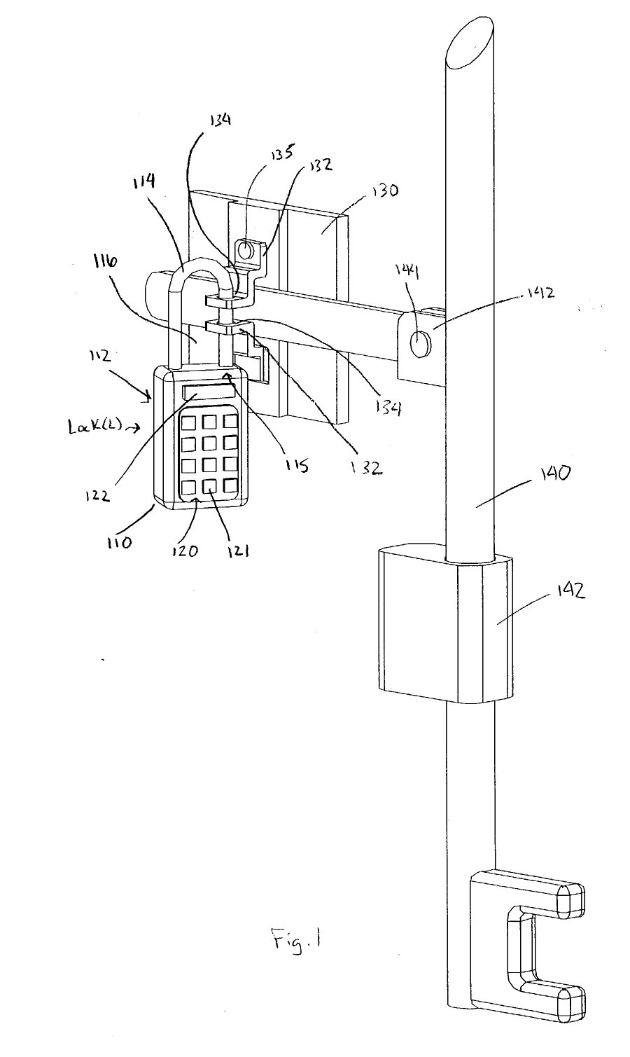

Referring to FIG. 1, an exemplary electronic lock 100 includes a housing 110 that contains a locking mechanism 112. Persons of ordinary skill in the art will recognize that various locking mechanisms can be utilized and that the lock can be designed in different ways. For example, the lock can be in the form of a padlock. The lock housing and other sections such as the locking member or shackle can be made of protective and durable materials including, but not limited to, 304 grade stainless steel. Further, the locking mechanism can be one of many known key, combination, and/or cam locking mechanisms. Thus, a specific locking mechanism is not discussed in further detail. In one embodiment, the electronic lock is in the form of a padlock that can include various locking mechanisms. For example, the locking system can include a lock that forms a padlock with a lock housing, a locking mechanism and a lockable member. The user interface and memory are integrated into the padlock. The locking mechanism 112 releasably couples a lockable member 114 slidably moveable within passageways 115 of the housing 110. The lockable member 114 includes one or more segments that can be secured by the locking mechanism 112 to define a space 116 for releasing and receiving a part or component of the container to be secured, e.g., a locking hinge or other lockable body.

The lock 100 also includes an electronic user interface 120. Data can be input by a user via the user interface 120, which can be for example, a keypad or keyboard 121, a Liquid Crystal Display (LCD), or an audio receiver. A keypad user interface can include numbers, letters, symbols, or a combination thereof, and users can input numeric, alpha, or symbol codes, i.e., data via the keypad. One exemplary keypad 121 that can be used is part no. 88AC2-ND, available from Digi-Key Corporation, 701 Brooks Avenue South, Thief River Falls, Minn. With a LCD interface, segments of the display can indicate certain numbers, letters or symbols. A user can enter data or a selection by touching the corresponding section displayed in the LCD. One exemplary LCD screen that can be used is part no. 153-1036-ND, which is also available from Digi-Key Corporation. As a final exemplary user interface, an audio receiver can detect a person's voice and convert it to an appropriate input signal. One audio receiver that can be used is part no. INA137UA-ND, also available from Digi-Key Corporation.

The user interface 120 can also include a display 122 indicating the data entered by the user. Persons of ordinary skill in the art will recognize that various electronic user interfaces can be used, and that the lock can be designed with different shapes and sizes to accommodate the user interface.

FIG. 1 illustrates one exemplary application of an electronic lock in the form of a padlock for sealing a container of a shipping trailer. Persons or ordinary skill in the art will recognize that various trailers and shipping containers can be sealed with the electronic lock of the present invention. For example, the lock can be used to seal refrigerated, metal, chemical, food, truck, ship, cargo, and railroad containers or trailers. However, for purposes of explanation, this specification refers to truck or shipping containers or trailers, but the invention is not so limited. In one example, a door 130 of the trailer (only a portion of the door is illustrated) includes lower and upper hinges 132 secured thereto. The hinges include apertures 134 through which the lockable member 114 can be inserted. The bottom hinge is secured or fixed to the door. The top hinge is rotatable about a pin 135. The design of the hinges defines a receiving area or cavity 136.

The trailer door includes a bar 140 that is rotatable within a mounting member 142 secured to the door. A lever 144 is rotatable about a pin 146 secured to the flange 142. Thus, in this exemplary trailer configuration, the lever 144 can rotate about pin 146 about a horizontal axis. When the trailer is to be sealed, bar 140 is pivoted into a position such that lever 144 can be rotated downward to rest upon the lower hinge or within the receiving cavity defined by the hinges. The upper hinge can then be rotated about pin 136 to be aligned with the lower hinge. The lockable member 114 is inserted through the apertures 134 of the aligned hinges 132. The electronic lock 100 can then be secured to seal the trailer. Indeed, persons of ordinary skill in the art will recognize that the present invention has application to container and trailer configurations.

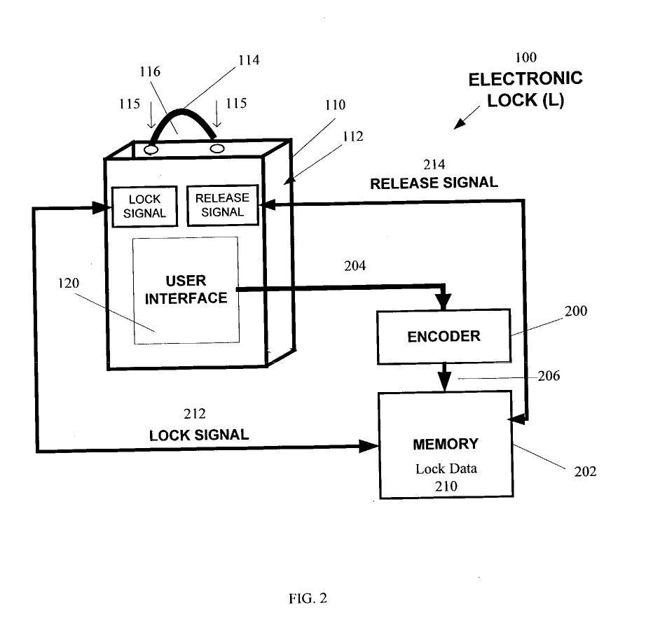

FIG. 2 illustrates additional components of the electronic lock of FIG. 1. The lock housing includes an encoder 200 and a memory 202. The encoder 200 and memory 202 are partially or completely enclosed within the housing 110, but are illustrated in FIG. 2 as separated from the lock housing for purposes of illustration. A user enters data (input data 204) via the user interface 120. Input data 204 can have one or more numbers, characters or symbols. One exemplary form of input data 204 is serial data, such as an identification or seal number. If necessary, the serial input data 204 can be converted into an appropriate format 206 with the encoder 200 for comparison with lock data 210 stored in memory 202. The memory 202 can be one of many standard memory components such as, for example, a Read Only Memory (ROM), Programmable ROM (PROM) or Erasable PROM (EPROM).

The lock code or lock data 210 is loaded to and stored in the memory 202. The lock code can be loaded into memory via a computer or, for example, a wireless or acoustic communications device. Input data 204 entered by the user or customer is compared with the lock data 210. Based on the comparison results, the memory 202 can output a lock signal 212 or a release signal 214. More specifically, a determination is made whether the input data 204 and lock data 210 match or satisfy other criteria.

If the input and lock data do not match or do not satisfy the criteria, then the memory 202 outputs a lock signal 212. Thus, the lock 100 is maintained in a lock state and the container can not be accessed. As a result, the container or trailer remains sealed.

If the input data 204 and the lock data 210 match or satisfy the criteria, then the memory 202 outputs a release signal 214. The release signal 214 triggers the locking mechanism 212 to change from a lock state to a release state, thereby releasing the lockable member and allowing access to the container.

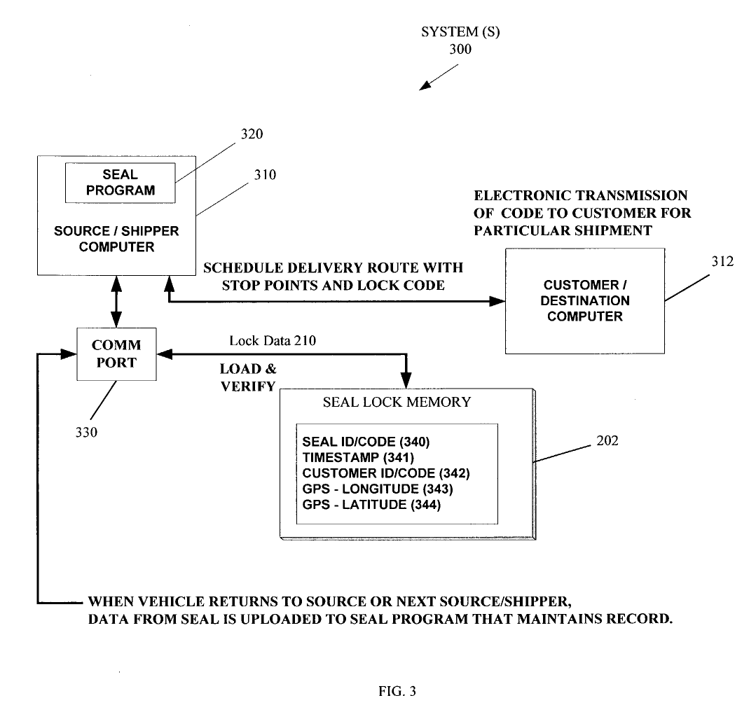

With reference to FIG. 3, the electronic lock 100 can be used in connection with a computer and communications link or network 300. The computer and communications network can be used to monitor or track the status or location of containers or trailers, and whether the lock was released. The exemplary system includes an electronic lock, a source computer 310 or computer at the initial or shipping location of a container, and a communications link to transmit data to/from the lock. The source computer 310 includes a seal program 320 for tracking and managing the locking/unlocking of the lock or sealing/unsealing of the container and related information.

Persons of ordinary skill in the art will recognize that a “computer” can be various computing or processing devices. Example computing devices include, but are not limited to, a laptop computer, a desktop computer, or a hand held computing devices such as a Personal Digital Assistant (PDA). Moreover, those persons of ordinary skill in the art will recognize that different communications systems can be utilized for communications between the source computer and the lock or between the source computer or lock and a shipper or receiver. Exemplary communications networks, links, systems or devices that can be used include wireless communications systems such as a cellular telephone network, satellite, acoustic communications, and modem or communicating port communications, Internet, Ethernet, or other devices, links, or protocols. Thus, the exemplary system can be implemented using various systems.

Lock data 210 is initially entered into the source computer 310 via a communications port or system 330 by the source or shipper. The lock data is transmitted to a customer computer 312 for a particular shipment as, for example, an electronic mail (e-mail) message or in another format or via a different communications system. Upon receiving the lock data 210 in an e-mail message or other form, the customer possesses the data and can enter input data after the locked container arrives.

The lock data 210 can be a unique code or data programmed for a particular shipment or for a particular product. For example, the lock data can be different numbers and sequences of numbers, letters, and/or symbols. Thus, as illustrated in FIG. 3, the lock data can be a seal number or other identification code 340. Thus, if the lock data comprises a seal number, the user or customer can enter the seal number through the electronic user interface. If the data matches or satisfies other criteria, the electronic lock is released and the container or trailer seal can be broken.

Alternatively, the lock data can be location data, such as the longitude 343 and latitude 344 coordinates of a Global Positioning System (GPS) or other location tracking system. In this alternative embodiment of the invention, the seal lock memory is programmed with lock data 210 in the form of coordinates of the location of the container's destination, or the location where the container can be opened. The user input data includes coordinates of the current location of the container. If the current location data and destination or lock location data match or satisfy other criteria, then the electronic lock can be released and the container or trailer seal can be broken. Persons of ordinary skill in the art will recognize that different types and combinations of lock data can be used and that an identification number, seal number, and location data are merely illustrative of many lock codes or data.

Application data related to a shipment, trailer, container, lock or seal can also be transmitted back to the source computer 310 through a modem or other communications device or link device to verify and confirm the information. Additionally, the electronic lock can be configured to generate a timestamp 341 indicating when the seal is broken or the lock is released. Timestamp information and the identification of the customer 342 that broke the seal or released the lock can be transmitted back to the source computer 310 for storage, filing or further processing. Further, when the container or vehicle with the container returns to the source location or arrives at the next “source” or loading location, data indicating that the container shipment has been completed can be uploaded back to the source computer 310 to complete records relating to the shipment.

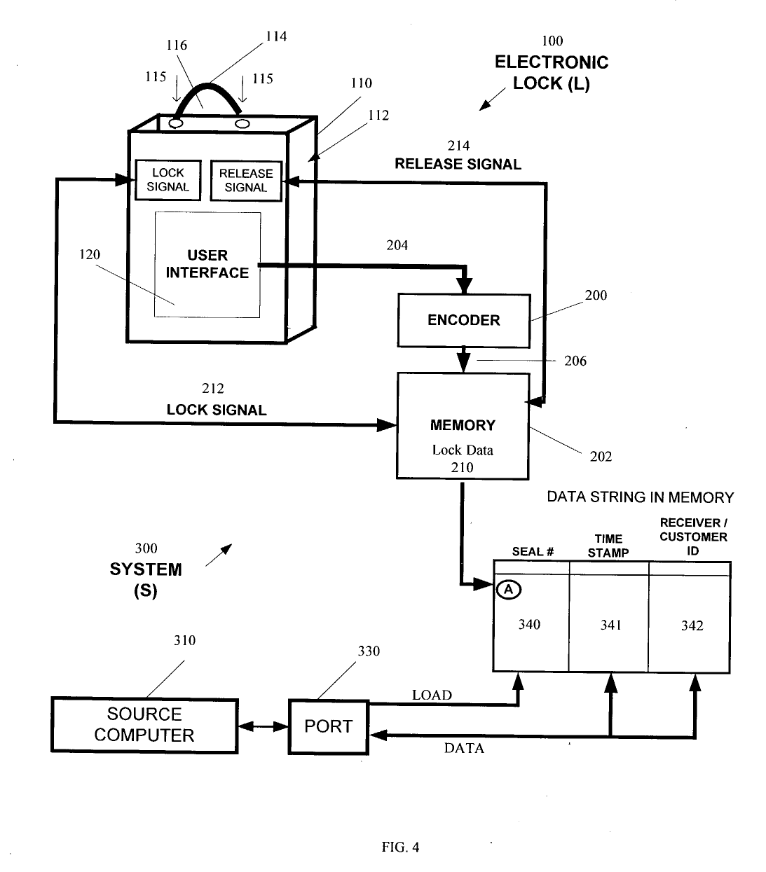

FIG. 4 illustrates an exemplary system including an electronic lock 100, source computer 310, and one example format of data that can be loaded to the electronic lock memory 202 and/or the source computer 310. Initially, lock data 210 is loaded from the source computer 310, through the communications port 330, to the electronic lock memory 202. An exemplary data string that can be stored in the memory includes a row “A” with seal number 340, timestamp 341, and receiver identification (ID) or customer ID 342 fields. Further, the timestamp 341 and customer ID 342 data can be transmitted from the source computer 310 to the memory 202, and from the memory 202 to the source computer 310.

As FIG. 4 illustrates, the memory 202 points to entry “A” as the data row that should be compared or processed. Thus, when a user inputs data through the user interface 120, the data is stored to the memory 202. Input data 204 and lock data 210 (in this example, the seal number 340) referenced by “pointer A” are compared. As previously discussed, if the input data 204 and lock data 210 match or satisfy other criteria, then the lock is released and the seal can be broken. Timestamp data 341 and customer identification data 342 can also be transmitted back to the source computer 310.

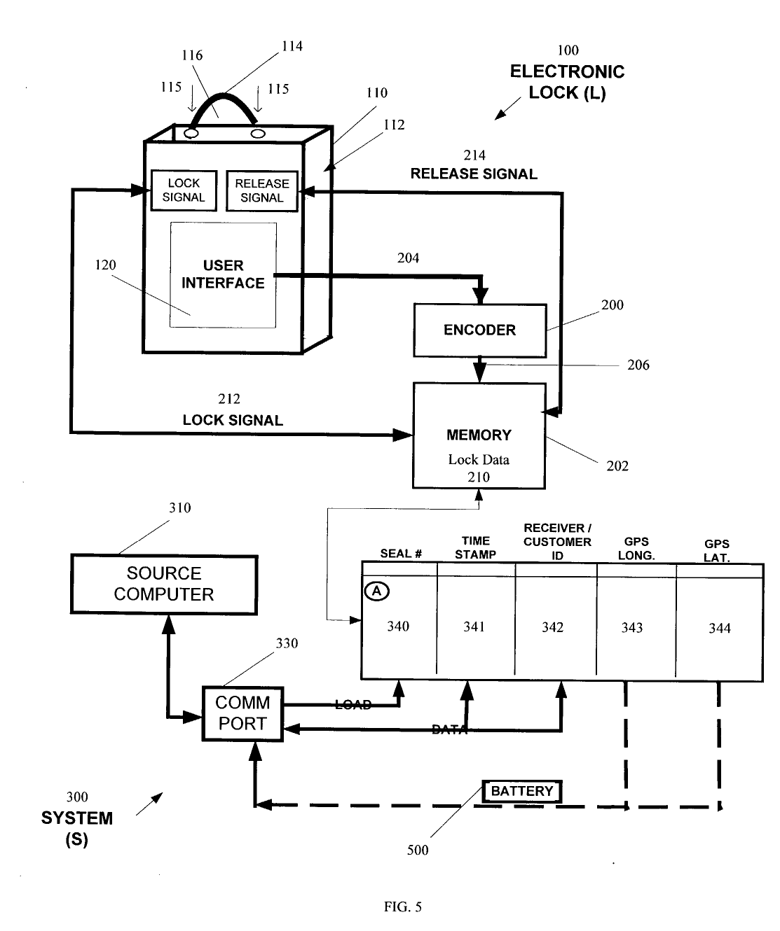

FIG. 5 illustrates an alternative data format that can be utilized. The alternative data format includes the same data previously discussed and, in addition, GPS or location data. Specifically, the data string can include a longitudinal GPS coordinate 343 and a latitude GPS coordinate 344. Using a GPS system will usually require a battery 500 to power the GPS processor (not shown). As previously mentioned, location data can serve as a lock data 210. When the current location coordinates of the container match the destination location coordinates or satisfy other criteria, the lock can be released since the container has reached its intended destination. Similar to the timestamp 341 and customer identification data 342, the GPS location data 343, 344 can be loaded to the lock memory 202 and transmitted back to the source computer 310.

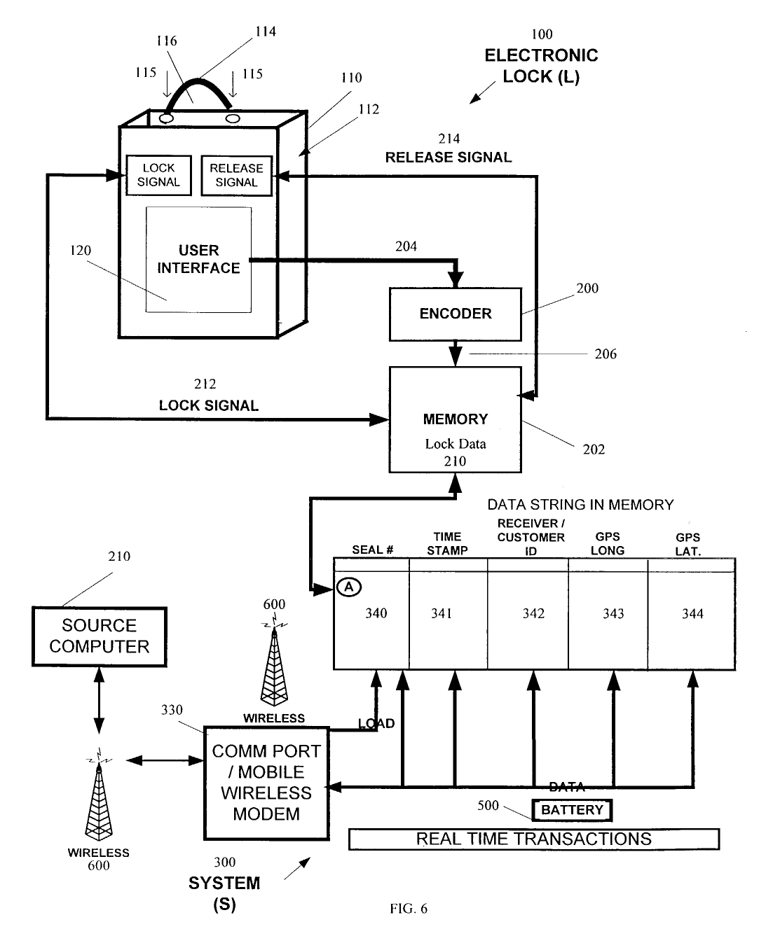

FIG. 6 illustrates yet another alternative embodiment of the invention that utilizes a wireless communications system 600 as the communications port 330. The wireless communications system 600 can be, for example, a cellular telephone, satellite communications system or acoustic communications system. In this embodiment, the source computer 310 communicates via a wireless link 600 with the electronic lock 100 and transmits lock data 210, e.g., the seal identification number 340 to the memory 210. As in the previously described systems, the timestamp 341, customer identification 342, and GPS data 343, 344 can be stored to the lock memory 202 and uploaded to the source computer 310 as necessary.

The wireless system 600 provides a further benefit in that the current location of the truck or container can be continuously or periodically monitored. In other words, the wireless system 600 enables real-time tracking of the container shipment. For example, the current location of the container can be monitored and transmitted back through the wireless modem to the source computer in real-time. This real-time monitoring system is advantageous since the seal program can be expanded to coordinate the schedule of arrival times of the containers based on the current location and expected time of arrival at the destination. These coordination activities optimize the time of the drivers and customers, thereby increasing efficiency and reducing costs.

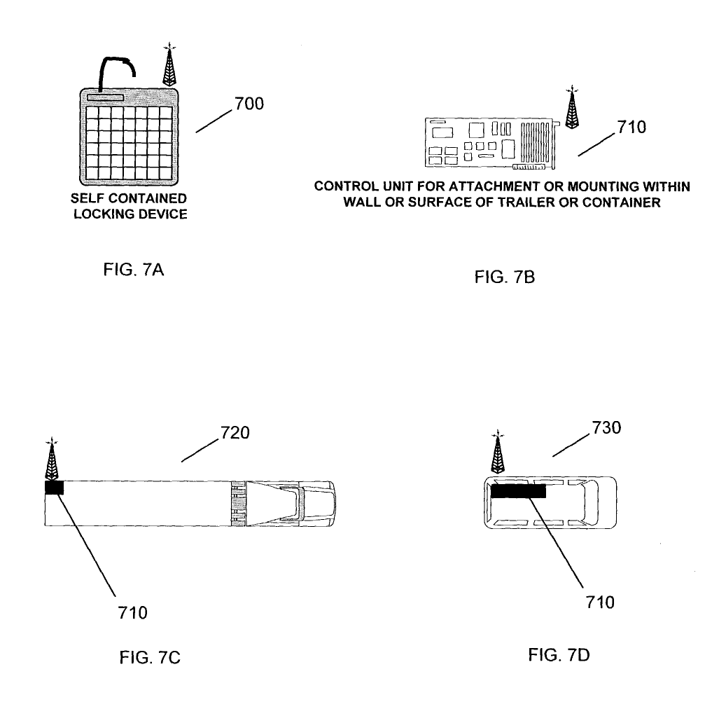

Persons of ordinary skill in the art will appreciate that the electronic lock and locking system can be configured in different ways. For example, referring to FIGS. 7A-D, the electronic lock components can be a self-contained unit 700 within a housing (FIG. 7A), use original parts of a trailer or container 720, 730, or be distributed in different portions of the trailer or container. Thus, one or more components of the electronic lock are integrated into the trailer instead of utilizing a padlock-type lock or housing, as illustrated in FIG. 1. The electronic user interface, such as a keypad, can be mounted to or integrated into a door of the container or trailer. The encoder and memory or control circuit 720 (FIG. 7B) can also be mounted elsewhere to or in the container walls or surfaces of the trailer or container 720, 730 (FIGS. 7C-D). Persons of ordinary skill in the art will recognize that various self-contained and distributed locking systems that use one or more components of a trailer can be utilized.

The release and lock signals can be provided from the control circuit or component 720 that provides lock and release signals to an actuation or solenoid (not shown) which can be mounted to or within the trailer walls to drive pre-existing locking components or bars of the trailer (e.g., lock illustrated in FIG. 1). Thus, the release signal can trigger the solenoid to activate and move the bars from a lock position to a release position. Further, a wireless transceiver can be mounted to various parts of the trailer or container (FIGS. 7C-D) or to within the lock housing (FIG. 7A). Thus, the electronic lock and locking system are adaptable to many locking, container, storage, and shipping applications.

Having described an exemplary electronic lock and electronic locking system, following is a description of the method of electronically controlling the locking and unlocking of a container or trailer with an electronic lock.

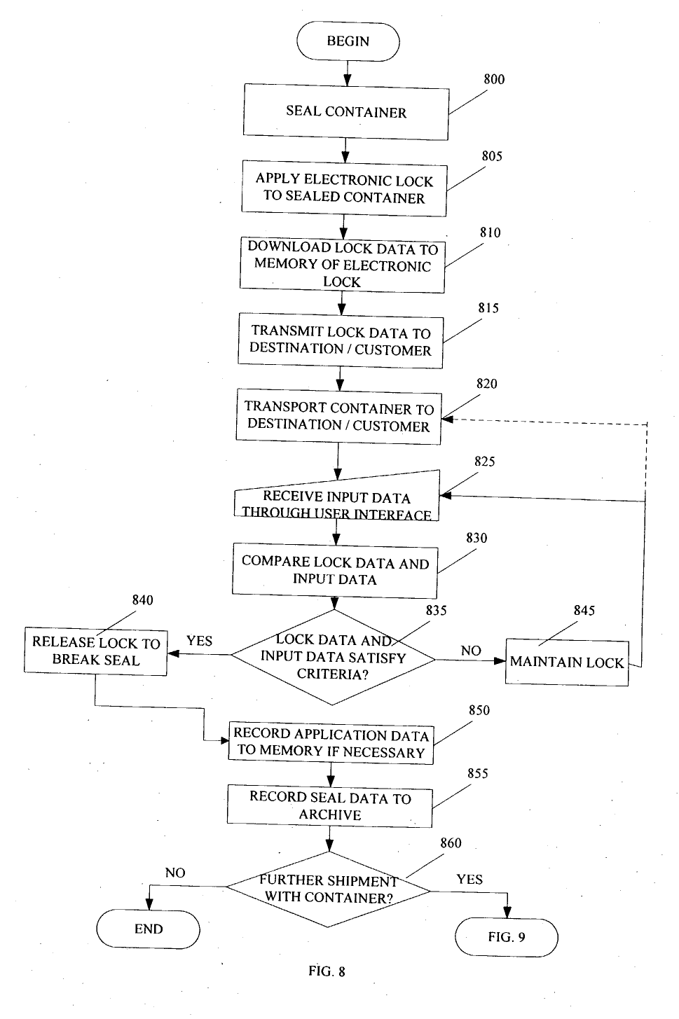

Referring now to FIG. 8, at the source location, a container is loaded with a product, such as a food item, chemical or other product and sealed in step 800. The electronic lock is applied to the container or trailer to secure the container in step 805. The shipper or source downloads lock data from the source computer to the memory of the electronic lock in step 810 (e.g., via a wireless or other communications link). The electronic lock is then programmed with the lock data (e.g., seal identification number or location data). After the lock is secured and programmed with lock data, it can later be released with the same data or input data satisfying other criteria entered by the user or customer.

In step 815, lock data is transmitted to the destination or customer via, for example, the Internet as an e-mail message or other communications system. Persons skilled in the art will recognize that various communications systems can be used to transmit lock data to the customer. The vehicle with the locked container then departs the source location in step 820, and the container is transported to the destination or customer.

Upon arriving at the destination, in step 825, the customer enters input data into the electronic user interface of the electronic lock. The programmed lock data stored in the lock memory and the data input by the customer are then compared in step 830. A determination of whether the lock can be released and whether the container seal can be broken is made based on the comparison in step 835.

Assuming the customer received the lock data or data and correctly entered it into the electronic user interface, the lock data should match the input data. In this case, the lock is released and the container seal can be broken in step 840. However, if the customer enters the wrong input data such that the unlocking criteria is not satisfied, then the lock will not be released and the seal cannot be broken, step 845. In this case, the customer must re-enter the data in step 820.

A customer having the wrong data may also indicate that the vehicle is in the wrong location. In other words, the customer in the correct location may have received the correct data (e.g., an identification number or location data), and an intermediate person with an incorrect data is attempting to open the container, which can not be opened with that data. Thus, the electronic lock system prevents inadvertent breaches by not allowing access to the container, thereby preventing potential contamination. As the vehicle proceeds from the intermediate location to the destination, it can be opened and accessed by the customer having the correct lock data.

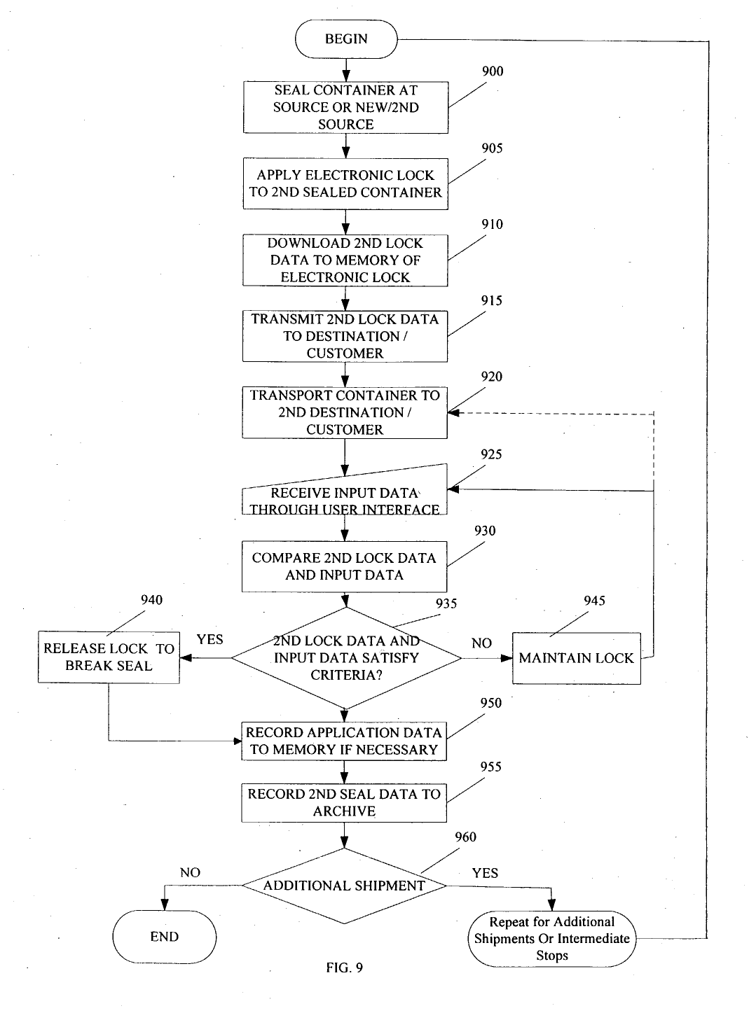

Continuing with step 850, application data, such as a timestamp indicating when the seal was broken or a customer identification, can also be loaded to the lock memory. The data can also be uploaded to the source computer in step 855. If there are no further shipments, then the process ends. Otherwise, the process can repeat for additional shipments or intermediate stops as illustrated in FIG. 9.

Referring to FIG. 9, if the container is used for a subsequent shipment, the container is returned to the initial source or to the next “source” in step 900. Steps 905-960 are similar to the steps 805-860 but applied to a second, intermediate or subsequent shipment. Thus, the same process can be implemented for subsequent shipments or intermediate stops.

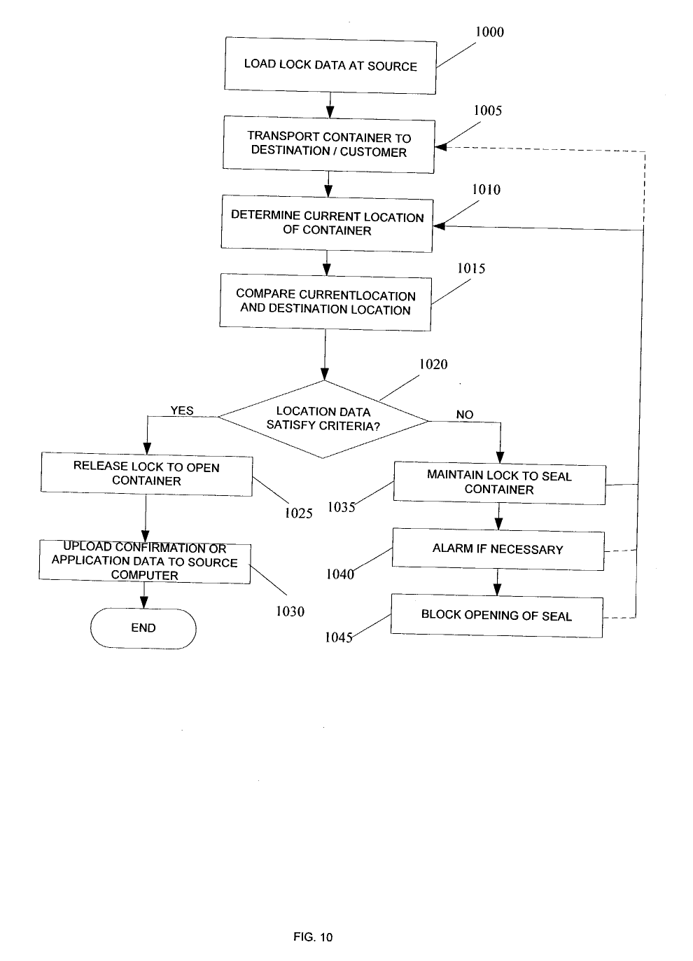

FIG. 10 illustrates how location data can serve as the lock data or lock code. More specifically, in step 1000, the source or shipper loads lock data to the lock memory which, in this case, are location coordinates (e.g., GPS coordinates) of the intended destination of the container. The lock data or location coordinates can also identify another location where it is permissible to release the lock and open the container. Then, in step 1005, the lock is applied to the container. In step 1010, the container is transported to the customer. From the time of departure, the current location of the truck/container can be periodically or continuously monitored in step 1015 with, e.g., a GPS or satellite tracking system. More specifically, monitoring can be performed through the use of a wireless system that feeds GPS data back to the source computer. In step 1020, the current GPS location and the destination GPS location can be periodically or continuously compared. In step 1025, a determination is made whether the current location data and destination location match or satisfy other criteria.

In step 1030, the lock is released and the container can be opened if the input and lock data match or satisfy the criteria. The application data, such as the time when the seal was broken and the customer identification, can be uploaded to the source computer and seal program in step 1040. However, if the location data does not match or satisfy the criteria, then in step 1040, the lock is maintained to seal the container. As a result, the current location is determined again in step 1015, and/or the container is further transported to the destination location in step 1010.

In order to prevent a seal breach, in step 1045, an alarm can be activated to provide a visual and/or audio indication that the seal should not be broken, e.g., in response to entry of incorrect data. Such indicators warn the person attempting to open the lock that the seal should not be broken. As a further option, if an alarm is activated, a signal can be transmitted back to the source computer in step 1050. Then, the source or shipper can act upon the alarm to address any potential problems, contact the customer, or contact the authorities as necessary to investigate whether someone is attempting to break into the trailer or container.

Although references have been made in the foregoing description to various embodiments, persons of ordinary skill in the art of designing food winding units and related systems will recognize that insubstantial modifications, alterations, and substitutions can be made to the described embodiments without departing from the invention as claimed in the accompanying claims. Thus, while the preferred embodiment is described as utilizing a lock data as a seal identification number and/or GPS location data, those persons of ordinary skill in the art will recognize that other types of lock data can also be utilized. Further, those persons of ordinary skill in the art will recognize that other types of application data can be recorded. Moreover, while the specification refers to a modem or wireless link to download and upload data, other communication systems can also be used.

Additionally, the live GPS data can be used by the shipper for various applications, including to verify correct routes for security reasons and that the correct trailer is being transported.

What is claimed is:

1. An electronic locking system for sealing a container, comprising:
an electronic lock, said electronic lock comprising:
a portable lock housing;
a locking mechanism within said housing, said mechanism being moveable between a lock position and a release position;
a lock member releasably secured by said locking mechanism and defining a space for releasing and receiving a part of the container;
an electronic user interface for receiving input data; and
an electronic memory configured to store said input data and lock data;
a source computer; and
a communications link, wherein said lock data is transmitted from said source computer to said memory of said electronic lock via said communications link, and
said input data and said lock data are compared to determine whether a criteria is satisfied to release said electronic lock to open the container based on the comparison.

2. The portable electronic locking system of claim 1, wherein said user interface comprises a keypad.

3. The portable electronic locking system of claim 2, wherein said keypad is configured for numeric, alpha or symbol input data.

4. The portable electronic locking system of claim 1, wherein said user interface comprises a Liquid Crystal Display (LCD).

5. The portable electronic locking system of claim 1, wherein said user interface comprises an audio receiver configured to receive audio input data.

6. The portable electronic locking system of claim 1, wherein said memory outputs a lock signal to said locking mechanism to maintain said mechanism in the lock position when said input data and said lock data do not satisfy said criteria, thereby maintaining a locked container.

7. The portable electronic locking system of claim 1, wherein said memory outputs a release signal to release said locking mechanism from the lock position to the release position when said input said lock data satisfy said criteria, thereby permitting the container to be opened.

8. The portable electronic locking system of claim 1, wherein said lock data is transmitted to said memory of said electronic lock before said input data is received.

9. The portable electronic locking system of claim 1, wherein said lock data comprises a seal identification number.

10. The portable electronic locking system of claim 1, wherein said lock data comprises location data where this container can be opened.

11. The electronic locking system of claim 10, wherein said location data comprises a global positioning system (GPS) location.

12. The electronic locking system of claim 10, wherein said input data comprises a current location of the container and said lock data comprises a location where the container can be opened, and whether said locking mechanism can be released is based on a comparison of said current location input data and said lock location data.

13. The portable electronic locking system of claim 12, wherein said locking mechanism is released if said location lock data and the location input data satisfy said criteria.

14. The portable electronic locking system of claim 1, further comprising an encoder for receiving said input data and configuring said input data for comparison with said lock data.

15. The portable electronic locking system of claim 1, wherein said memory is further configured to store application data related to the container.

16. The portable electronic locking system of claim 15, wherein said application data comprises a timestamp indicating when said locking mechanism was released.

17. The portable electronic locking system of claim 15, wherein said application data comprises a customer identification.

18. The portable electronic locking system of claim 1, wherein said lock data is transmitted to said memory at a source or point of shipment.

19. The portable electronic locking system of claim 1, wherein said lock housing, said locking mechanism and said lockable member form a padlock, said user interface and said memory being integrated into said padlock.

20. The portable electronic locking system of claim 1, wherein said communications link comprises a modem.

21. The portable electronic locking system of claim 1, wherein said source computer is further configured to send and receive application data through said communications link.

22. The portable electronic locking system of claim 21, wherein said application data comprises a timestamp of when said locking mechanism was released.

23. The portable electronic locking system of claim 21, wherein said application data comprises a customer or destination identification.

24. The portable electronic locking system of claim 21, wherein after said source computer receives confirmation that said locking mechanism was released based, said source computer being configured to transmit new lock data to said memory through said communications link.

25. The portable electronic locking system of claim 1, wherein said communications link comprises a wireless link.

26. The portable electronic locking system of claim 25, wherein said source computer is further configured to send and receive application data through said wireless link.

27. The portable electronic locking system of claim 25, wherein said wireless link is used to track the location of the container in real-time.

28. The portable electronic locking system of claim 1, wherein said locking mechanism, said lock member, said electronic user interface, and said electronic memory are contained within said portable lock housing.

29. The portable electronic locking system of claim 1, wherein
said locking mechanism comprises a locking mechanism of the container.

30. The portable electronic locking system of claim 1, wherein said lock member comprises a lock member of the container.

31. The portable electronic locking system of claim 1, wherein said electronic user interface is integrated into a door or wall of the container.

32. The portable locking system of claim 1, wherein one or more components of said electronic lock are integrated into the trailer.

33. A method of electronically controlling the locking and unlocking of a container with a portable electronic lock, the electronic lock including a lock housing, a locking mechanism moveable between a locking position and a release position within the housing, and a lock member releasably secured by the locking mechanism and defining a space for releasing and receiving a part of the container, the method comprising:
transmitting lock data from a source computer through a communications link to an electronic memory of the electronic lock;
receiving input data to the electronic memory;
comparing the lock data and the input data; and
determining whether to unlock the locking mechanism to permit the container to be opened based on the comparison.

34. The method of claim 33, wherein transmitting the lock data further comprises transmitting an identification number.

35. The method of claim 33, wherein transmitting lock data further comprises transmitting a location where the container can be unlocked.

36. The method of claim 33, wherein receiving input data further comprises receiving input data through a keypad.

37. The method of claim 33, wherein receiving input data further comprises receiving a current location of the container through a global positioning system (GPS), and wherein the lock data comprises a destination location where the electronic lock can be opened.

38. The method of claim 33, further comprising loading application data relating to the container to the source computer.

39. The method of claim 38, wherein loading application data further comprises loading a timestamp indicating when the electronic lock was unlocked.

40. The method of claim 38, wherein loading application data further comprises loading a customer identification.

41. The method of claim 33, further comprising generating a signal from said memory to release the locking mechanism from the lock state to the release state.

42. The method of claim 33, further comprising generating a signal in said memory to maintain the electronic lock in the lock state.

43. The method of claim 33, further comprising encoding the received input data into a format that can be compared with the lock data.

44. The method of claim 33, wherein transmitting lock data from the source computer further comprises transmitting lock data from the source computer through a modem to the electronic memory.

45. The method of claim 33, wherein transmitting lock data to the memory further comprises transmitting lock data from the source computer through a wireless link to the memory.

46. The method of claim 33, further comprising:
tracking a current location of the container in real-time; and
transmitting the current location data to the memory, wherein the received current location data and the lock data comprising destination location data are compared.

47. The method of claim 46, wherein real-time tracking is performed through a global positioning system (GPS).
